(19) United States
(12) Patent Application Publication
(10) Pub. No.: US 2026/0005244 A1
(43) Pub. Date: Jan. 1, 2026

(54) POSITIVE ELECTRODE FOR NON-AQUEOUS ELECTROLYTE SECONDARY BATTERY AND METHOD FOR MANUFACTURING SAME, AND NON-AQUEOUS ELECTROLYTE SECONDARY BATTERY, BATTERY MODULE, AND BATTERY SYSTEM USING SAME

(71) Applicant: SEKISUI CHEMICAL CO., LTD., Osaka (JP)

(72) Inventors: Hikaru YOSHIKAWA, Tsukuba-shi (JP); Junnosuke AKIIKE, Tsukuba-shi (JP)

(73) Assignee: SEKISUI CHEMICAL CO., LTD., Osaka (JP)

(21) Appl. No.: 19/102,475

(22) PCT Filed: Aug. 30, 2023
(86) PCT No.: PCT/JP2023/031548

§ 371 Date: Feb. 10, 2025

(30) Foreign Application Priority Data
Aug. 30, 2022 (JP) 2022-136905

(51) Int. Cl. H01M 4/58; H01M 4/02; H01M 10/052

(52) U.S. Cl. CPC H01M 4/5825; H01M 10/052; H01M 2004/021; H01M 2004/028

(57) ABSTRACT

A positive electrode for a non-aqueous electrolyte secondary battery, including a current collector and a positive electrode active material layer which includes positive electrode active material particles and is provided on the current collector, wherein: the positive electrode active material layer has a BET specific surface area of 10 m²/g or more and 30 m²/g or less; and a median particle diameter (D50) of particles present in the positive electrode active material layer is 0.5 μm or more and 1.5 μm or less, as measured by a laser diffraction scattering method with respect to the positive electrode active material layer having been peeled off.

### TECHNICAL FIELD

The present invention relates to a positive electrode for non-aqueous electrolyte secondary battery and a method for producing the same, as well as a non-aqueous electrolyte secondary battery, a battery module, and a battery system, each using the positive electrode.

Priority is claimed on Japanese Patent Application No. 2022-136905, filed Aug. 30, 2022, the contents of which are incorporated herein by reference.

### BACKGROUND ART

A non-aqueous electrolyte secondary battery is generally composed of a positive electrode, a non-aqueous electrolyte, a negative electrode, and a separation membrane (hereinafter, also referred to as “separator”) installed between the positive electrode and the negative electrode.

A conventionally known positive electrode for a non-aqueous electrolyte secondary battery is formed by pressing a composition composed of a positive electrode active material containing lithium ions, a conducting agent, and a binder to be fixed on the surface of a metal foil as a current collector, thereby forming a positive electrode active material layer.

Examples of the practically used positive electrode active material containing lithium ions include lithium transition metal composite oxides such as lithium cobalt oxide, lithium nickel oxide, and lithium manganese oxide, and lithium phosphate compounds such as lithium iron phosphate.

Patent Document 1 describes that in order to obtain a positive electrode for a non-aqueous electrolyte secondary battery with excellent input/output performance, the BET specific surface area of the positive electrode active material represented by LiₓA_{y}M_{z}PO₄ is set to be 5 m²/g or more and 30 m²/g or less.

### CITATION LIST

### Patent Document

Patent Document 1: Japanese Patent Granted Publication No. 6725022

### SUMMARY OF INVENTION

### Technical Problem

However, simply adjusting the BET specific surface area of the positive electrode active material does not result in a positive electrode for a non-aqueous electrolyte secondary battery with excellent input/output performance. In addition, non-aqueous electrolyte secondary batteries for automotive use can deteriorate when stored or used at high temperatures, resulting in a decrease in input/output performance, and there is a problem concerning how to maintain the performance after exposure to high-temperature environments.

The present invention provides a positive electrode for a non-aqueous electrolyte secondary battery, which enables production of a non-aqueous electrolyte secondary battery excellent in maintaining output performance when stored or used at high temperatures.

### Solution to Problem

As a result of extensive and intensive studies, the present inventors have made the following findings.

When the amount of the conducting agent in the positive electrode active material layer is small, side reactions associated with an increase in resistance originating from the conducting agent can be suppressed.

In the present invention, by specifying the specific surface area of the positive electrode active material layer measured by the BET method and the median particle diameter (D50) in particle size distribution measurement for the positive electrode active material particles obtained by peeling the positive electrode active material layer off from the current collector, it is possible to provide a non-aqueous electrolyte secondary battery that has high initial input/output performance and maintains the input/output performance even after a calendar test.

The embodiments of the present invention are as follows.
[1]A positive electrode for a non-aqueous electrolyte secondary battery, comprising a current collector and a positive electrode active material layer which includes positive electrode active material particles and is provided on the current collector, wherein:
   the positive electrode active material layer has a BET specific surface area of 10 m²/g or more and 30 m²/g or less; and
   a median particle diameter (D50) of particles present in the positive electrode active material layer is 0.5 μm or more and 1.5 μm or less, as measured by a laser diffraction scattering method with respect to the positive electrode active material layer having been peeled off.
[2] The positive electrode according to [1], wherein the positive electrode active material layer comprises a conductive carbon, and an amount of the conductive carbon is 0.5% by mass or more and less than 3.5% by mass or less with respect to a total mass of the positive electrode active material layer.
[2-1] The positive electrode according to [1], wherein the positive electrode active material layer comprises a conductive carbon, and an amount of the conductive carbon is 1.0 to 3.0% by mass, or 1.2 to 2.8% by mass or less with respect to a total mass of the positive electrode active material layer.
[3] The positive electrode according to any one of [1] to [2-1], wherein the positive electrode active material particles comprise a compound represented by a formula LiFeₓM₍₁₋ₓ₎PO₄, wherein 0≤x≤1, M is Co, Ni, Mn, Al, Ti or Zr.
[4] The positive electrode according to any one of [1] to [3], wherein a current collector coating layer comprising a conductive material is present on at least a part of a surface of the positive electrode current collector on a side of the positive electrode active material layer.
[5] The positive electrode according to any one of [1] to [4], wherein the positive electrode active material layer does not contain a conducting agent.
[5-1] The positive electrode according to any one of [1] to [5], wherein the specific surface area is 13 m²/g or more and 27 m²/g or less, and the median particle diameter (D50) is 0.6 μm or more and 1.4 μm or less.
[5-2] The positive electrode according to any one of [1] to [5], wherein the specific surface area is 16 m²/g or more and 24 m²/g or less, and the median particle diameter (D50) is 0.6 μm or more and 1.3 μm or less.
[5-3] The positive electrode according to any one of [1] to [5], wherein the specific surface area is 17.5 m²/g or more and 27 m²/g or less, and the median particle diameter (D50) is 0.6 μm or more and less than 1.3 μm.
[5-4] The positive electrode according to any one of [1] to [5], wherein the specific surface area is 19.0 m²/g or more and 24 m²/g or less, and the median particle diameter (D50) is 0.6 μm or more and 1.0 μm or less.
[6]A non-aqueous electrolyte secondary battery, comprising the positive electrode of any one of [1] to [5-4], a negative electrode, and a non-aqueous electrolyte disposed between the positive electrode and the negative electrode.
[7]A battery module or battery system including a plurality of the non-aqueous electrolyte secondary batteries of [6].

### Advantageous Effects of Invention

The present invention can provide a positive electrode for a non-aqueous electrolyte secondary battery, which enables production of a non-aqueous electrolyte secondary battery that can maintain high output performance even when used or stored in high temperature environments.

### BRIEF DESCRIPTION OF DRAWINGS

FIG. 1 is a cross-sectional view schematically showing an example of a positive electrode for a non-aqueous electrolyte secondary battery according to the present invention.

FIG. 2 is a cross-sectional view schematically showing an example of a non-aqueous electrolyte secondary battery according to the present invention.

### DESCRIPTION OF EMBODIMENTS

In the present specification and claims, “to” indicating a numerical range means that the numerical values described before and after “to” are included as the lower limit and the upper limit of the range.

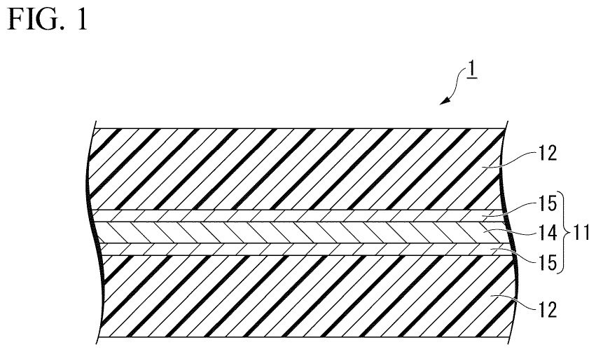

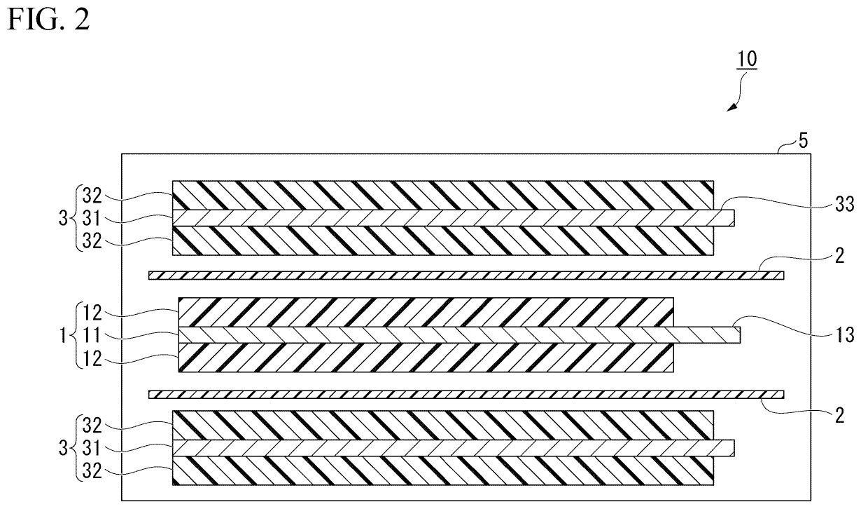

FIG. 1 is a schematic cross-sectional view showing one embodiment of the positive electrode of the present invention for a non-aqueous electrolyte secondary battery, and FIG. 2 is a schematic cross-sectional view showing one embodiment of the non-aqueous electrolyte secondary battery of the present invention.

FIG. 1 and FIG. 2 are schematic diagrams for facilitating the understanding of the configurations, and the dimensional ratios and the like of each component do not necessarily represent the actual ones.

### <Positive Electrode for Non-Aqueous Electrolyte Secondary Battery>

In the present embodiment, the positive electrode for a non-aqueous electrolyte secondary battery (hereinafter also referred to as “positive electrode”) 1 has a current collector (hereinafter referred to as “positive electrode current collector”) 11 and a positive electrode active material layer 12.

The positive electrode active material layer 12 is present on at least one surface of the positive electrode current collector 11. The positive electrode active material layers 12 may be present on both sides of the positive electrode current collector 11.

In the example shown in FIG. 1, the positive electrode current collector 11 has current collector coating layers 15 on its surfaces facing the positive electrode active material layers 12. That is, the positive electrode current collector 11 has a positive electrode current collector main body 14 and current collector coating layers 15 that cover the positive electrode current collector main body 14 on its surfaces facing the positive electrode active material layers 12. The positive electrode current collector main body 14 alone may be used as the positive electrode current collector 11.

### [Positive Electrode Active Material Layer]

The positive electrode active material layer 12 includes positive electrode active material particles.

The positive electrode active material layer 12 preferably further includes a binder.

The positive electrode active material layer 12 may further include a conducting agent. In the context of the present specification, the term “conducting agent” refers to a conductive material of a particulate shape, a fibrous shape, etc., which is mixed with the positive electrode active material for the preparation of the positive electrode active material layer or formed in the positive electrode active material layer, and is caused to be present in the positive electrode active material layer in a form connecting the particles of the positive electrode active material. That is, in the positive electrode 1 of the present embodiment, the conducting agent is exclusively the conductive particles intentionally added to the positive electrode active material layer 12.

The positive electrode active material layer 12 may further include a dispersant.

The amount of the positive electrode active material particles is preferably 80.0 to 99.9% by mass, and more preferably 90 to 99.5% by mass, based on the total mass of the positive electrode active material layer 12.

The thickness of the positive electrode active material layer 12 (total thickness of the positive electrode active material layer 12 on both sides of the positive electrode current collector 11 when the positive electrode active material layer 12 is present on both sides) is preferably 30 to 500 μm, more preferably 40 to 400 μm, particularly preferably 50 to 300 μm. When the thickness of the positive electrode active material layer 12 is not less than the lower limit value of the above range, the energy density of a battery with the positive electrode incorporated therein tends to improve. When the thickness is not more than the upper limit value of the above range, the peel strength of the positive electrode active material layer 12 can be improved, thereby preventing delamination of the positive electrode active material layer 12 during charging/discharging.

The positive electrode active material layer 12 is porous.

The median particle diameter (D50) of the particles present in the positive electrode active material layer 12, as measured by a laser diffraction scattering method with respect to the positive electrode active material layer 12 having been peeled off from the positive electrode current collector 11 is 0.5 μm or more and 1.5 μm or less, preferably 0.6 μm or more and 1.4 μm or less, more preferably 0.7 μm or more and 1.3 μm or less. In one embodiment of the present invention, the median particle diameter (D50) is preferably 0.6 μm or more and 1.3 μm or less, more preferably 0.6 μm or more and less than 1.3 μm, even more preferably 0.6 μm or more and 1.0 μm or less. When the mediane particle diameter (D50) of the particles present in the positive electrode active material layer 12 is not less than the lower limit value described above, sufficient reaction surface area can be secured during charging and discharging, and hence improvement of output performance can be expected. When the median particle diameter (D50) of the particles present in the positive electrode active material layer 12 is not more than the upper limit value described above, the expansion of the particles in a high temperature (60° C. or higher) environment and the contraction when returning to room temperature (from 10 to 30° C.) are within an acceptable range; therefore, the distance between particles is not too large inside the positive electrode active material layer 12, the conductive path is maintained, and the resistance increase can be suppressed.

In the present specification, the mediane particle diameter (D50) is a median diameter determined based on the particle size distribution curve (hereinafter also referred to as the “particle size distribution curve P”) of the particles present in the positive electrode active material layer 12.

The particle size distribution curve P is a volume-based particle size distribution curve measured with a particle size distribution measuring device using a laser diffraction/scattering method. The particle size distribution curve P may be shown as a frequency distribution curve in which particle diameters are plotted on the abscissa, and frequency values (unit: %) are plotted on the ordinate, or an integrated distribution curve in which particle diameters are plotted on the abscissa, and integrated values of the frequency (unit: %) are plotted on the ordinate.

A sample used for the measurement is an aqueous dispersion prepared by detaching the positive electrode active material layer 12 from the positive electrode 1 and dispersing the particles that had been present in the positive electrode active material layer 12 in water. It is preferable to ultrasonically treat the aqueous dispersion to sufficiently disperse the particles.

The particles as measurement target here are typically positive electrode active material particles described below. When the positive electrode active material layer 12 contains particles of a conducting agent described below, such particles are also included in the measurement target.

Further, with regard to the adjustment of the median particle diameter (D50), it is possible to control the median particle diameter (D50) to fall within a predetermined range by appropriately adjusting the particle diameter of the positive electrode active material particles used for forming the positive electrode active material layer 12, and, if a conducting agent is used, the particle diameter and amount of the conducting agent particles added.

### [Positive Electrode Active Material Particles]

The positive electrode active material particles include a positive electrode active material. At least a part of the positive electrode active material particles is a coated particle.

In the coated particles, a coating section containing a conductive material (hereinafter, also referred to as “active material coating section”) is present on the surfaces of the positive electrode active material particles. The active material coating section of the active material particles enables the positive electrode active material particles to further enhance the battery capacity and cycling performance.

For example, the active material coating section is formed in advance on the surface of the positive electrode active material particles, and is present on the surface of the positive electrode active material particles in the positive electrode active material layer. That is, the active material coating section in the present specification is not one newly formed in the steps following the preparation step of a positive electrode composition. In addition, the active material coating section is not one that comes off in the steps following the preparation step of a positive electrode composition.

For example, the active material coating section stays on the surface of the positive electrode active material even when the coated particles are mixed with a solvent by a mixer or the like during the preparation of a positive electrode composition. Further, the active material coating section stays on the surface of the positive electrode active material even when the positive electrode active material layer is detached from the positive electrode and then put into a solvent to dissolve the binder contained in the positive electrode active material layer in the solvent. Furthermore, the active material coating section stays on the surface of the positive electrode active material even when an operation to disintegrate agglomerated particles is implemented for measuring the particle size distribution of the particles in the positive electrode active material layer by the laser diffraction scattering method.

The active material coating section of the active material particles preferably covers 50% or more, preferably 70% or more, and more preferably 90% or more of the total area of the entire outer surfaces of the positive electrode active material particles.

That is, the coated particles have a core section that is a positive electrode active material and an active material coating section that covers the surface of the core section, and the area ratio (coverage) of the active material coating section with respect to the surface area of the core section is preferably 50% or more, more preferably 70% or more, and even more preferably 90% or more.

Examples of the method for producing the coated particles include a sintering method and a vapor deposition method.

Examples of the sintering method include a method that sinters an active material composition (for example, a slurry) containing the positive electrode active material particles and an organic substance at 500 to 1000° C. for 1 to 100 hours under atmospheric pressure. Examples of the organic substance added to the active material composition include salicylic acid, catechol, hydroquinone, resorcinol, pyrogallol, fluoroglucinol, hexahydroxybenzene, benzoic acid, phthalic acid, terephthalic acid, phenylalanine, water dispersible phenolic resins, saccharides (e.g., sucrose, glucose and lactose), carboxylic acids (e.g., malic acid and citric acid), unsaturated monohydric alcohols (e.g., allyl alcohol and propargyl alcohol), ascorbic acid, and polyvinyl alcohol. This sintering method sinters an active material composition to allow carbon in the organic material to be fused to the surface of the positive electrode active material to thereby form the active material coating section.

Another example of the sintering method is the so-called impact sintering coating method.

The impact sintering coating method is, for example, carried our as follows. In an impact sintering coating device, a burner is ignited using a mixed gas of a hydrocarbon and oxygen as a fuel to burn the mixed gas in a combustion chamber, thereby generating a flame, wherein the amount of oxygen is adjusted so as not to exceed its equivalent amount that allows complete combustion of the fuel, to thereby lower the flame temperature. A powder supply nozzle is installed downstream thereof, from which a solid-liquid-gas three-phase mixture containing a combustion gas as well as a slurry formed by dissolving an organic substance for coating in a solvent is injected toward the flame. The injected fine powder is accelerated at a temperature not higher than the transformation temperature, the sublimation temperature, and the evaporation temperature of the powder material by increasing the amount of combustion gas maintained at room temperature to lower the temperature of the injected fine powder. This allows the particles of the powder to be instantly fused on the active material by impact, thereby forming coated particles of the positive electrode active material. Examples of the vapor deposition method include a vapor phase deposition method such as a physical vapor deposition method (PVD) and a chemical vapor deposition method (CVD), and a liquid phase deposition method such as plating.

The coverage can be measured by a method as follows. First, the particles in the positive electrode active material layer are analyzed by the energy dispersive X-ray spectroscopy (TEM-EDX) using a transmission electron microscope. Specifically, an elemental analysis is performed by EDX with respect to the outer peripheral portion of the positive electrode active material particles in a TEM image. The elemental analysis is performed on carbon to identify the carbon covering the positive electrode active material particles. A section with a carbon coating having a thickness of 1 nm or more is defined as a coating section, and the ratio of the coating section to the entire circumference of the observed positive electrode active material particle can be determined as the coverage. The measurement can be performed with respect to, for example, 10 positive electrode active material particles, and an average value thereof can be used as a value of the coverage.

With respect to the coverage of the positive electrode active material particles, the determination can also be implemented by calculation from TEM-EDX elemental mapping of particles with elements specific to the positive electrode active material and elements specific to the conductive material in the active material coating section of the active material. Similarly, a ratio of the active material coating section to the entire circumference of the observed positive electrode active material particle may be determined as the coverage, with the coating being defined as at least 1 nm-thick portion of the element specific to the conductive material. The measurement can be performed with respect to, for example, 10 positive electrode active material particles, and an average value thereof can be used as a value of the coverage.

Further, the active material coating section is a layer directly formed on the surface of particles (core section) composed of only the positive electrode active material, which has a thickness of 1 nm to 100 nm, preferably 5 nm to 50 nm. This thickness can be determined by the above-mentioned TEM-EDX used for the measurement of the coverage.

In the present invention, the area ratio (coverage) of the active material coating section in the coated particles is particularly preferably 100% with respect to the surface area of the core section.

This coverage (%) is an average value for all the positive electrode active material particles present in the positive electrode active material layer. As long as this average value is not less than the above lower limit value, the positive electrode active material layer may contain positive electrode active material particles without the active material coating section. When the positive electrode active material particles (single particles) without the active material coating section are present in the positive electrode active material layer, the amount thereof is preferably 30% by mass or less, more preferably 20% by mass or less, and particularly preferably 10% by mass or less, with respect to the total mass of the positive electrode active material particles present in the positive electrode active material layer.

The specific surface area of the positive electrode active material layer 12 measured by the BET method is 10 m²/g or more and 30 m²/g or less, preferably 13 m²/g or more and 27 m²/g or less, more preferably 16 m²/g or more and 24 m²/g or less. In one embodiment of the present invention, the specific surface area is preferably more than 17.5 m²/g and not more than 27 m²/g, more preferably more than 19.0 m²/g and not more than 24 m²/g. When the specific surface area of the positive electrode active material layer 12 measured by the BET method is not less than the lower limit value described above, a sufficient reaction surface area can be secured during charging and discharging, thereby improving the output performance. When the specific surface area of the positive electrode active material layer 12 measured by the BET method is not more than the upper limit value described above, an increase in resistance due to a side reaction with the electrolyte in a high temperature (60° C.) environment can be suppressed, thereby enabling the output performance to be maintained.

The specific surface area of the positive electrode active material layer 12 by the BET method can be measured by a BET plot using a gas adsorption method. Examples of measuring and analyzing devices include TriStar II 3020 (specific surface area measuring device) manufactured by Shimadzu-Micromeritics, and VacPrep 061 (pretreatment device) manufactured by Shimadzu-Micromeritics. 1.0 g of a sample cut into strips is placed in a ½ inch cell, and degassed (dried under reduced pressure) for about 12 hours at 130° C. using the pretreatment device. The resulting is subjected to measurement by the N₂ gas adsorption method. Since the results obtained in this case are applicable only to the positive electrode active material layer 12, the specific surface area (m²/g) is calculated using the value obtained by subtracting the weight of the current collector 11 from the weight of the sample.

The conductive material of the active material coating section of the active material preferably contains carbon (conductive carbon). The conductive material may be composed only of carbon, or may be a conductive organic compound containing carbon and elements other than carbon. Examples of the other elements include nitrogen, hydrogen, oxygen and the like. In the conductive organic compound, the amount of the other elements is preferably 10 atomic % or less, and more preferably 5 atomic % or less. It is more preferable that the conductive material in the active material coating section is composed only of carbon.

The amount of the conductive material is 0.1 to 4.0% by mass, more preferably 0.5 to 3.0% by mass, even more preferably 0.7 to 2.5% by mass, based on the total mass of the positive electrode active material particles. Excessive amount of the conductive material is not favorable in that the conductive material may come off the surface of the positive electrode active material particles and remain as isolated conducting agent particles.

In the positive electrode 1 of the present embodiment, the conductive carbon refers to the total of the conducting agent in the positive electrode active material layer 12, the active material coating section on the positive electrode active material surface, and the coating section on the current collector foil.

The positive electrode active material preferably contains a compound having an olivine crystal structure.

The compound having an olivine crystal structure is preferably a compound represented by the following formula: LiFeₓM₍₁₋ₓ₎PO₄ (hereinafter, also referred to as “formula (I)”). In the formula (I), 0≤x≤1. M is Co, Ni, Mn, Al, Ti or Zr. A minute amount of Fe and M (Co, Ni, Mn, Al, Ti or Zr) may be replaced with another element so long as the replacement does not affect the physical properties of the compound. The presence of a trace amount of metal impurities in the compound represented by the formula (I) does not impair the effect of the present invention.

The compound represented by the formula (I) is preferably lithium iron phosphate represented by LiFePO₄ (hereinafter, also referred to as “lithium iron phosphate”).

The positive electrode active material particles are more preferably lithium iron phosphate particles having, on at least a part of their surfaces, an active material coating section including a conductive material (hereinafter, also referred to as “coated lithium iron phosphate particles”). It is more preferable that the entire surface of lithium iron phosphate particles is coated with a conductive material for achieving more excellent battery capacity and cycling performance.

The coated lithium iron phosphate particles can be produced by a known method.

For example, the coated lithium iron phosphate particles can be obtained by a method in which a lithium iron phosphate powder is prepared by following the procedure described in Japanese Patent No. 5098146, and at least a part of the surface of lithium iron phosphate particles in the powder is coated with carbon by following the procedure described in GS Yuasa Technical Report, June 2008, Vol. 5, No. 1, pp. 27-31 and the like.

Specifically, first, iron oxalate dihydrate, ammonium dihydrogen phosphate, and lithium carbonate are weighed to give a specific molar ratio, and these are pulverized and mixed in an inert atmosphere. Next, the obtained mixture is heat-treated in a nitrogen atmosphere to prepare a lithium iron phosphate powder. Then, the lithium iron phosphate powder is placed in a rotary kiln and heat-treated while supplying methanol vapor with nitrogen as a carrier gas to obtain a powder of lithium iron phosphate particles having at least a part of their surfaces coated with carbon.

For example, the particle size of the lithium iron phosphate powder can be adjusted by optimizing the crushing time in the crushing process. The amount of carbon coating the particles of the lithium iron phosphate powder can be adjusted by optimizing the heating time and temperature in the step of implementing heat treatment while supplying methanol vapor. It is desirable to remove the carbon particles not consumed for coating by subsequent steps such as classification and washing.

The positive electrode active material particles may include at least one type of other positive electrode active material particles including other positive electrode active materials than the compound having an olivine type crystal structure.

Preferable examples of the other positive electrode active materials include a lithium transition metal composite oxide. Specific examples thereof include lithium cobalt oxide, lithium nickel oxide, lithium nickel cobalt aluminum oxide (LiNiₓCo_{y}Al_{z}O₂ with the proviso that x+y+z=1), lithium nickel cobalt manganese oxide (LiNiₓCo_{y}Mn_{z}O₂ with the proviso that x+y+z=1), lithium manganese oxide, lithium manganese cobalt oxide, lithium manganese chromium oxide, lithium vanadium nickel oxide, nickel-substituted lithium manganese oxide (e.g., LiMn_{1.5}Ni_{0.5}O₄), and lithium vanadium cobalt oxide (LiCoVO₄), as well as nonstoichiometric compounds formed by partially substituting the compounds listed above with metal elements. Examples of the metal element include one or more selected from the group consisting of Mn, Mg, Ni, Co, Cu, Zn and Ge.

The other positive electrode active particles material may have, on at least a part of surfaces thereof, the active material coating section described above.

The amount of the compound having an olivine type crystal structure is preferably 50% by mass or more, preferably 80% by mass or more, and even more preferably 90% by mass or more, based on the total mass of the positive electrode active material particles (including the mass of the active material coating section if present). The amount of the compound having an olivine type crystal structure may be 100% by mass, based on the total mass of the positive electrode active material particles. When the coated lithium iron phosphate particles are used, the amount of the coated lithium iron phosphate particles is preferably 50% by mass or more, more preferably 80% by mass or more, and even more preferably 90% by mass or more, based on the total mass of the positive electrode active material particles. This amount may be 100% by mass.

The thickness of the active material coating section of the positive electrode active material particles is preferably 1 to 100 nm.

The thickness of the active material coating section of the positive electrode active material particles can be measured by a method of measuring the thickness of the active material coating section in a transmission electron microscope (TEM) image of the positive electrode active material particles. The thickness of the active material coating sections on the surfaces of the positive electrode active material particles need not be uniform. It is preferable that the positive electrode active material particles have, on at least a part of surfaces thereof, the active material coating section having a thickness of 1 nm or more, and the maximum thickness of the coated section is 100 nm or less.

The median particle diameter of the positive electrode active material particles used in forming the positive electrode active material layer 12 (including the thickness of the active material coating section if the active material coating section is present) is 0.1 to 20.0 μm, more preferably 0.5 to 15.0 μm. When two or more types of positive electrode active materials are used, the median particle diameter of each of such positive electrode active materials may be within the above range. When the median particle diameter is not less than the lower limit value of the above range, the specific surface area (unit: m²/g) becomes appropriately large, and it becomes easier to secure an area for reaction during charging and discharging. As a result, the resistance of the battery decreases and the rapid charging performance is less likely to deteriorate. On the other hand, when the average particle size is not more than the upper limit value of the above range, the specific surface area becomes appropriately small, which tends to improve dispersibility in the positive electrode composition and suppress generation of agglomerates. As a result, the conductive paths between particles become uniform inside the positive electrode active material layer 12, so that the rapid charging performance is likely to improve.

The median particle diameter of the positive electrode active material particles in the present specification is a volume-based median particle diameter measured using a laser diffraction/scattering particle size distribution analyzer.

### [Binder]

The binder that can be contained in the positive electrode active material layer 12 is an organic substance, and examples thereof include polyacrylic acid, lithium polyacrylate, polyvinylidene fluoride, polyvinylidene fluoride-hexafluoropropylene copolymers, styrene butadiene rubbers, polyvinyl alcohol, polyvinyl acetal, polyethylene oxide, polyethylene glycol, carboxymethyl cellulose, polyacrylic nitrile, and polyimide. With respect to the binder, a single type thereof may be used alone or two or more types thereof may be used in combination.

### [Conducting Agent]

Examples of the conducting agent contained in the positive electrode active material layer 12 include carbon materials such as graphite, graphene, hard carbon, Ketjen black, acetylene black, and carbon nanotube. With respect to the conducting agent, a single type thereof may be used alone or two or more types thereof may be used in combination.

The amount of the conducting agent in the positive electrode active material layer 12 is, for example, preferably 4 parts by mass or less, more preferably 3 parts by mass or less, and even more preferably 1 part by mass or less, relative to 100 parts by mass of the positive electrode active material. It is particularly preferable that the positive electrode active material layer does not contain a conducting agent, and it is desirable that there are no isolated conducting agent particles (for example, isolated carbon particles).

When the conducting agent is incorporated into the positive electrode active material layer 12, the lower limit value of the amount of the conducting agent is appropriately determined according to the type of the conducting agent, and is, for example, more than 0.1% by mass, based on the total mass of the positive electrode active material layer.

In the context of the present specification, the expression “the positive electrode active material layer 12 does not contain a conducting agent” or similar expression means that the positive electrode active material layer 12 does not substantially contain a conducting agent, and should not be construed as excluding a case where a conducting agent is contained in such an amount that the effects of the present invention are not affected. For example, if the amount of the conducting agent is 0.1% by mass or less, based on the total mass of the positive electrode active material layer, then, it is judged that substantially no conducting agent is contained.

Conducting agent particles that do not contribute to the creation of conductive path may become a site where self-discharge of the battery starts or a cause of undesirable side reactions.

### [Dispersant]

The dispersant contained in the positive electrode active material layer 12 is an organic substance, and examples thereof include polyvinylpyrrolidone (PVP), polyvinyl alcohol (PVA), polyvinyl butyral (PVB), and polyvinylformal (PVF). With respect to these dispersants, a single type thereof may be used individually or two or more types thereof may be used in combination.

The dispersant prevents the particles in the positive electrode active material layer 12 from agglomerating, and contributes to the creation of a good conductive path. On the other hand, when the dispersant content is too high, the resistance increases and the input performance tends to deteriorate.

The amount of the dispersant is preferably 0.5% by mass or less, more preferably 0.2% by mass or less, based on the total mass of the positive electrode active material layer 12.

When the positive electrode active material layer 12 contains a dispersant, the lower limit of the amount of the dispersant is preferably 0.01% by mass or more, more preferably 0.05% by mass or more, based on the total mass of the positive electrode active material layer 12.

### [Positive Electrode Current Collector Main Body]

The positive electrode current collector body 14 is formed of a metal material. Examples of the metal material include conductive metals such as copper, aluminum, titanium, nickel, and stainless steel.

The thickness of the positive electrode current collector main body 14 is preferably, for example, 8 to 40 μm, and more preferably 10 to 25 μm.

The thickness of the positive electrode current collector main body 14 and the thickness of the positive electrode current collector 11 can be measured using a micrometer. One example of the measuring instrument usable for this purpose is an instrument with the product name “MDH-25M”, manufactured by Mitutoyo Co., Ltd.

### [Current Collector Coating Layer]

It is preferable that the positive electrode current collector main body 14 has, on at least a part of its surface, a current collector coating layer 15. The current collector coating layer 15 contains a conductive material.

In this context, the expression “at least a part of its surface” means 10 to 100%, preferably 30 to 100%, more preferably 50 to 100% of the area of the surface of the positive electrode current collector main body 14.

The conductive material in the current collector coating layer 15 preferably contains carbon (conductive carbon). The conductive material is more preferably one composed only of carbon.

The current collector coating layer 15 is preferred to be, for example, a coating layer containing carbon particles such as carbon black and a binder. Examples of the binder for the current collector coating layer 15 include those listed above as examples of the binder for the positive electrode active material layer 12.

With regard to the production of the positive electrode current collector 11 in which the surface of the positive electrode current collector main body 14 is coated with the current collector coating layer 15, for example, the production can be implemented by a method in which a composition (i.e., composition for preparing the current collector coating layer) containing the conductive material, the binder, and a solvent is applied to the surface of the positive electrode current collector main body 14 with a known coating method such as a gravure method, followed by drying to remove the solvent.

The thickness of the current collector coating layer 15 is preferably 0.1 to 4.0 μm. The thickness of the current collector coating layer 15 can be measured by a method that measures the thickness of the coating layer in a transmission electron microscope (TEM) image or a scanning electron microscope (SEM) image of a cross section of the current collector coating layer 15. The thickness of the current collector coating layer need not be uniform. It is preferable that the current collector coating layer 15 having a thickness of 0.1 μm or more is present on at least a part of the surface of the positive electrode current collector main body 14, and the maximum thickness of the current collector coating layer 15 is 4.0 μm or less.

### [Conductive Carbon Content]

In the present embodiment, the positive electrode active material layer 12 preferably includes conductive carbon. Examples of the embodiment in which the positive electrode active material layer contains the conductive carbon include the following embodiments 1 to 3.

Embodiment 1: The positive electrode active material layer contains a conducting agent; and the conducting agent includes conductive carbon.

Embodiment 2: The positive electrode active material layer contains a conducting agent; the positive electrode active material particles have, on at least a part of surfaces thereof, an active material coating section containing a conductive material; and one or both of the conductive material in the active material coating section and the conducting agent includes conductive carbon.

Embodiment 3: The positive electrode active material layer does not contain a conducting agent; the positive electrode active material particles have, on at least a part of surfaces thereof, an active material coating section containing a conductive material; and the conductive material in the active material coating section includes conductive carbon.

Embodiment 3 is more preferable in terms of increasing the mass ratio of the positive electrode active material in the positive electrode active material layer and increasing the gravimetric energy density of the battery.

The amount of the conductive carbon is preferably 0.5% by mass or more and less than 3.5 by mass, more preferably 1.0 to 3.0% by mass, and even more preferably 1.2 to 2.8% by mass, based on the total mass of the positive electrode active material layer 12.

When the amount of the conductive carbon in the positive electrode active material layer 12 is not less than the lower limit value of the above range, the amount is sufficient to form a conductive path in the positive electrode active material layer 12. When the amount is not more than the upper limit value described above, the dispersibility improves.

The conductive carbon content based the total mass of the positive electrode active material layer 12 can be measured by <<Method for measuring conductive carbon content >> described below with respect to a dried product (powder), as a measurement target, obtained by vacuum-drying, at 120° C., the positive electrode active material layer 12 detached from the positive electrode.

For example, the measurement target may be one obtained by detaching the outermost surface of the positive electrode active material layer 12 with a depth of several μm using a spatula or the like, and vacuum drying the resulting powder in an environment of 120° C.

The conductive carbon to be measured by the <<Method for measuring conductive carbon content>> described below includes carbon in the active material coating section, and carbon in the conducting agent. Carbon in the binder is not included in the conductive carbon to be measured. Carbon in the dispersant is not included in the conductive carbon to be measured.

### Method for Measuring Conductive Carbon Content>>

### [Measurement Method A]

A sample having a weight w1 is taken from a homogeneously mixed product of the measurement target, and the sample is subjected to thermogravimetry differential thermal analysis (TG-DTA) implemented by following step A1 defined below, to obtain a TG curve. From the obtained TG curve, the following first weight loss amount M1 (unit: % by mass) and second weight loss amount M2 (unit: % by mass) are obtained. By subtracting M1 from M2, the conductive carbon content (unit: % by mass) is obtained.

Step A1: A temperature of the sample is raised from 30° C. to 600° C. at a heating rate of 10° C./min and holding the temperature at 600° C. for 10 minutes in an argon gas stream of 300 mL/min to measure a resulting mass w2 of the sample, from which a first weight loss amount M1 is determined by formula (a1):

$$M 1 = ( w 1 - w 2 ) / w 1 \times 100 \qquad ( a1 )$$

Step A2: Immediately after the step A1, the temperature is lowered from 600° C. to 200° C. at a cooling rate of 10° C./min and held at 200° C. for 10 minutes, followed by completely substituting the argon gas stream with an oxygen gas stream. The temperature is raised from 200° C. to 1000° C. at a heating rate of 10° C./min and held at 1000° C. for 10 minutes in an oxygen gas stream of 100 mL/min to measure a resulting mass w3 of the sample, from which a second weight loss amount M2 (unit: % by mass) is calculated by formula (a2):

$$M 2 = ( w 1 - w 3 ) / w 1 \times 100 \qquad ( a2 )$$

### [Measurement Method B]

0.0001 mg of a precisely weighed sample is taken from a homogeneously mixed product of the measurement target, and the sample is burnt under burning conditions defined below to measure an amount of generated carbon dioxide by a CHN elemental analyzer, from which a total carbon content M3 (unit: % by mass) of the sample is determined. Also, a first weight loss amount M1 is determined following the procedure of the step A1 of the measurement method A. By subtracting M1 from M3, the conductive carbon content (unit: % by mass) is obtained.

### [Burning Conditions]

Combustion furnace temperature: 1150° C.
Temperature of reduction furnace: 850° C.
Helium flow rate: 200 mL/min.
Oxygen flow rate: 25 to 30 mL/min.

### [Measurement Method C]

The total carbon content M3 (unit: % by mass) of the sample is measured in the same manner as in the above measurement method B. Further, the carbon amount M4 (unit: % by mass) of carbon derived from the binder is determined by the following method. M4 is subtracted from M3 to determine a conductive carbon content (unit: % by mass).

When the binder is polyvinylidene fluoride (PVDF: monomer (CH₂CF₂), molecular weight 64), the conductive carbon content can be calculated by the following formula from the fluoride ion (F₋) content (unit: % by mass) measured by combustion ion chromatography based on the tube combustion method, the atomic weight (19) of fluorine in the monomers constituting PVDF, and the atomic weight (12) of carbon in the PVDF.

$$PVDF content ( unit : \% by mass ) = fluoride ion content ( unit : \% by mass ) \times 64 / 38$$

$$PVDF - derived carbon amount M 4 ( unit : \% by mass ) = fluoride ion content ( unit : \% by mass ) \times 12 / 19$$

The presence of polyvinylidene fluoride as a binder can be verified by a method in which a sample or a liquid obtained by extracting a sample with an N,N-dimethylformamide solvent is subjected to Fourier transform infrared spectroscopy to confirm the absorption attributable to the C—F bond. Such verification can be likewise implemented by nuclear magnetic resonance spectroscopy (¹⁹F-NMR).

When the binder is identified as being other than PVDF, the carbon amount M4 attributable to the binder can be calculated by determining the amount (unit: % by mass) of the binder from the measured molecular weight, and the carbon content (unit: % by mass).

When the dispersant is contained, the conductive carbon content (unit: % by mass) can be obtained by subtracting M4 from M3, and further subtracting therefrom the amount of carbon belonging to the dispersant.

These methods are described in the following publications:
Toray Research Center, The TRC News No. 117 (September 2013), pp. 34-37, [Searched on Feb. 10, 2021], Internet <https://www.toray-research.co.jp/technical-info/trcnews/pdf/TRC117(34-37).pdf>
TOSOH Analysis and Research Center Co., Ltd., Technical Report No. T1019 2017.09.20, [Searched on Feb. 10, 2021], Internet <http://www.tosoh-arc.co.jp/techrepo/files/tarc00522/T1719N.pdf>

### <<Analytical Method for Conductive Carbon>>

The conductive carbon in the active material coating section of the positive electrode active material and the conductive carbon as the conducting agent can be distinguished by the following analytical method.

For example, particles in the positive electrode active material layer are analyzed by a combination of transmission electron microscopy-electron energy loss spectroscopy (TEM-EELS), and particles having a carbon-derived peak around 290 eV only near the particle surface can be judged to be the positive electrode active material. On the other hand, particles having a carbon-derived peak inside the particles can be judged to be the conducting agent. In this context, “near the particle surface” means a region to the depth of approximately 100 nm from the particle surface, while “inside” means an inner region positioned deeper than the “near the particle surface”.

As another method, the particles in the positive electrode active material layer are analyzed by Raman spectroscopy mapping, and particles showing carbon-derived G-band and D-band as well as a peak of the positive electrode active material-derived oxide crystals can be judged to be the positive electrode active material particles that are the coated particles described above. On the other hand, particles showing only G-band and D-band can be judged to be the conducting agent.

As still another method, a cross section of the positive electrode active material layer is observed with scanning spread resistance microscope (SSRM). When the particle surface has a region with lower resistance than the inside of the particle, the region with lower resistance can be judged to be the conductive carbon present in the active material coating section. Other particles that are present isolatedly and have low resistance can be judged to be the conducting agent.

In this context, a trace amount of carbon considered to be an impurity and a trace amount of carbon unintentionally detached from the surface of the positive electrode active material during production are not judged to be the conducting agent.

Using any of these methods, it is possible to verify whether or not the conducting agent formed of carbon material is contained in the positive electrode active material layer.

### [Volume Density of Positive Electrode Active Material Layer]

In the present embodiment, the volume density of the positive electrode active material layer 12 is preferably 2.10 to 2.70 g/cm³, more preferably 2.25 to 2.50 g/cm³.

The volume density of the positive electrode active material layer can be measured by, for example, the following measuring method.

The thicknesses of the positive electrode 1 and the positive electrode current collector 11 are each measured with a micrometer, and the difference between these two thickness values is calculated as the thickness of the positive electrode active material layer 12. With respect to the thickness of the positive electrode 1 and the thickness of the positive electrode current collector 11, each of these thickness values is an average value of the thickness values measured at five or more arbitrarily chosen points. The thickness of the positive electrode current collector 11 may be measured at the exposed section 13 of the positive electrode current collector, which is described below.

The mass of the measurement sample punched out from the positive electrode 1 so as to have a predetermined area is measured, from which the mass of the positive electrode current collector 11 measured in advance is subtracted to calculate the mass of the positive electrode active material layer 12.

The volume density of the positive electrode active material layer 12 is calculated by the following formula (1).

$$Volume density ( unit : g / {cm}^{3} ) = mass of positive electrode active material layer ( unit : g ) / [ ( thickness of positive electrode active material layer ( unit : cm ) ) \times area of measurement sample ( unit : {cm}^{2} ) ] \qquad ( 1 )$$

When the volume density of the positive electrode active material layer 12 is not less than the lower limit value of the above range, the resulting nonaqueous electrolyte secondary battery is likely to show excellent input performance. When the volume density is not more than the upper limit value described above, cracks due to press load are unlikely to occur in the positive electrode active material layer 12, so that an excellent conductive path can be formed.

The volume density of the positive electrode active material layer 12 can be controlled by, for example, adjusting the amount of the positive electrode active material, the particle size of the positive electrode active material, the thickness of the positive electrode active material layer 12, and the like. When the positive electrode active material layer 12 contains a conducting agent, the volume density can also be controlled by selecting the type of the conducting agent (specific surface area, specific gravity), or adjusting the amount of the conducting agent, and the particle size of the conducting agent.

Further, less particle agglomeration of the particles that form the positive electrode active material layer 12 is likely to result in smaller thickness of the positive electrode active material layer 12 when the positive electrode active material layer 12 is pressed, which tends to result in a higher volume density. In addition, less particle aggregation is likely to improve dispersibility, so that good conductive paths can be formed in the positive electrode active material layer 12, thereby improving the rate performance.

### <Method for Producing Positive Electrode>

The present embodiment's method for producing the positive electrode 1 includes a composition preparation step of preparing a positive electrode composition containing a positive electrode active material, and a coating step of coating the positive electrode composition on the positive electrode current collector 11. For example, the positive electrode 1 can be produced by applying the positive electrode composition containing a positive electrode active material and a solvent onto the positive electrode current collector 11, followed by drying to remove the solvent to form the positive electrode active material layer 12. The positive electrode composition may contain a conducting agent. The positive electrode composition may contain a binder. The positive electrode composition may contain a dispersant.

The thickness of the positive electrode active material layer 12 can be adjusted by a method in which a layered body composed of the positive electrode current collector 11 and the positive electrode active material layer 12 formed thereon is placed between two flat plate jigs and, then, uniformly pressurized in the thickness direction of this layered body. For this purpose, for example, a method of pressurizing using a roll press can be used.

The solvent for the positive electrode composition is preferably a non-aqueous solvent. Examples of the solvent include alcohols such as methanol, ethanol, 1-propanol and 2-propanol; chain or cyclic amides such as N-methyl-2-pyrrolidone and N,N-dimethylformamide; and ketones such as acetone. With respect to these solvents, a single type thereof may be used individually or two or more types thereof may be used in combination.

### <Non-Aqueous Electrolyte Secondary Battery>

The non-aqueous electrolyte secondary battery 10 of the present embodiment shown in FIG. 2 includes a positive electrode 1 of the present embodiment, a negative electrode 3, and a non-aqueous electrolyte. Further, a separator 2 may be provided. Reference numeral 5 in FIG. 1 denotes an outer casing.

In the present embodiment, the positive electrode 1 has a plate-shaped positive electrode current collector 11 and positive electrode active material layers 12 provided on both surfaces thereof. The positive electrode active material layer 12 is present on a part of each surface of the positive electrode current collector 11. The edge of the surface of the positive electrode current collector 11 is an exposed section 13 of the positive electrode current collector, which is free of the positive electrode active material layer 12. A terminal tab (not shown) is electrically connected to an arbitrary portion of the exposed section 13 of the positive electrode current collector.

The negative electrode 3 has a plate-shaped negative electrode current collector 31 and negative electrode active material layers 32 provided on both surfaces thereof. The negative electrode active material layer 32 is present on a part of each surface of the negative electrode current collector 31. The edge of the surface of the negative electrode current collector 31 is an exposed section 33 of the negative electrode current collector, which is free of the negative electrode active material layer 32. A terminal tab (not shown) is electrically connected to an arbitrary portion of the exposed section 33 of the negative electrode current collector.

The shapes of the positive electrode 1, the negative electrode 3 and the separator 2 are not particularly limited. For example, each of these may have a rectangular shape in a plan view.

With regard to the production of the non-aqueous electrolyte secondary battery 10 of the present embodiment, for example, the production can be implemented by a method in which the positive electrode 1 and the negative electrode 3 are alternately interleaved through the separator 2 to produce an electrode layered body, which is then packed into an outer casing such as an aluminum laminate bag, and a non-aqueous electrolyte (not shown) is injected into the outer casing, followed by sealing the outer casing. FIG. 2 shows a representative example of a structure of the battery in which the negative electrode, the separator, the positive electrode, the separator, and the negative electrode are stacked in this order, but the number of electrodes can be altered as appropriate. The number of the positive electrode 1 may be one or more, and any number of positive electrodes 1 can be used depending on a desired battery capacity. The number of each of the negative electrode 3 and the separator 2 is larger by one sheet than the number of the positive electrode 1, and these are stacked so that the negative electrode 3 is located at the outermost layer.

### [Negative Electrode]

The negative electrode active material layer 32 includes a negative electrode active material. Further, the negative electrode active material layer 32 may further include a binder. Furthermore, the negative electrode active material layer 32 may include a conducting agent as well. The shape of the negative electrode active material is preferably particulate.

For example, the negative electrode 3 can be produced by a method in which a negative electrode composition containing a negative electrode active material, a binder and a solvent is prepared, and coated on the negative electrode current collector 31, followed by drying to remove the solvent to thereby form a negative electrode active material layer 32. The negative electrode composition may contain a conducting agent.

Examples of the negative electrode active material and the conducting agent include carbon materials, lithium titanate (LTO), silicon, silicon monoxide and the like.

Examples of the carbon materials include graphite, graphene, hard carbon, Ketjen black, acetylene black, and carbon nanotube (CNT). With respect to each of the negative electrode active material and the conducting agent, a single type thereof may be used alone or two or more types thereof may be used in combination.

Examples of the material of the negative electrode current collector 31 include those listed above as examples of the material of the positive electrode current collector 11. Examples of the binder in the negative electrode composition include polyacrylic acid (PAA), lithium polyacrylate (PAALI), polyvinylidene fluoride (PVDF), polyvinylidene fluoride-propylene hexafluoride copolymer (PVDF-HFP), styrene-butadiene rubber (SBR), polyvinyl alcohol (PVA), polyethylene oxide (PEO), polyethylene glycol (PEG), carboxymethyl cellulose (CMC), polyacrylonitrile (PAN), polyimide (PI) and the like. With respect to the binder, a single type thereof may be used alone or two or more types thereof may be used in combination.

Examples of the solvent in the negative electrode composition include water and organic solvents. Examples of the organic solvent include alcohols such as methanol, ethanol, 1-propanol and 2-propanol; chain or cyclic amides such as N-methyl-2-pyrrolidone (NMP) and N,N-dimethylformamide (DMF); and ketones such as acetone. With respect to these solvents, a single type thereof may be used individually or two or more types thereof may be used in combination.

The sum of the amount of the negative electrode active material and the amount of the conducting agent relative to the total mass of the negative electrode active material layer 32 is preferably 80.0 to 99.9% by mass, more preferably 85.0 to 98.0% by mass.

### [Separator]

The separator 2 is disposed between the negative electrode 3 and the positive electrode 1 to prevent a short circuit or the like. The separator 2 may retain a non-aqueous electrolyte described below.

The separator 2 is not particularly limited, and examples thereof include a porous polymer film, a non-woven fabric, and glass fiber.

An insulating layer may be provided on one or both surfaces of the separator 2. The insulating layer is preferably a layer having a porous structure in which insulating fine particles are bonded with a binder for an insulating layer.

The separator 2 may contain various plasticizers, antioxidants, and flame retardants.

Examples of the antioxidant include phenolic antioxidants such as hinderedphenolic antioxidants, monophenolic antioxidants, bisphenolic antioxidants, and polyphenolic antioxidants; hinderedamine antioxidants; phosphorus antioxidants; sulfur antioxidants; benzotriazole antioxidants; benzophenone antioxidants; triazine antioxidants; and salicylate antioxidants. Among these, phenolic antioxidants and phosphorus antioxidants are preferable.

### [Non-Aqueous Electrolyte Solution]

The non-aqueous electrolyte solution fills the space between the positive electrode 1 and the negative electrode 3. For example, any of known non-aqueous electrolyte solutions used in lithium ion secondary batteries, electric double layer capacitors and the like can be used.

The nonaqueous electrolyte used in the manufacture of the nonaqueous electrolyte secondary battery 10 contains an organic solvent, an electrolyte, and an additive.

After manufacture, especially after initial charging, the nonaqueous electrolyte secondary battery 10 contains an organic solvent and an electrolyte, and may further contain residues or traces derived from the additives.

The organic solvent is preferably one having tolerance to high voltage. Examples of the organic solvent include polar solvents such as ethylene carbonate, propylene carbonate, dimethyl carbonate, diethyl carbonate, ethyl methyl carbonate, γ-butyrolactone, sulfolane, dimethyl sulfoxide, acetonitrile, dimethylfornamide, dimethylacetamide, 1,2-dimethoxyethane, 1,2-diethoxyethane, tetrohydrafuran, 2-methyltetrahydrofuran, dioxolane, and methyl acetate, as well as mixtures of two or more of these polar solvents.

The electrolyte is not particularly limited, and examples thereof include lithium-containing salts such as LiClO₄, LiPF₆, LiBF₄, LiAsF₆, LiCF₃CO₂, LiN(SO₂F)₂, LiN(SO₂CF₃)₂, Li(SO₂CF₂CF₃)₂, LiN(COCF₃)₂, and LiN(COCF₂CF₃)₂, as well as mixture of two or more of these salts.

The non-aqueous electrolyte secondary battery of the present embodiment can be used as a lithium ion secondary battery for various purposes such as industrial use, consumer use, automobile use, and residential use.

The application of the non-aqueous electrolyte secondary battery of this embodiment is not particularly limited. For example, the battery can be used in a battery module configured by connecting a plurality of non-aqueous electrolyte secondary batteries in series or in parallel, a battery system including a plurality of electrically connected battery modules and a battery control system, and the like.

Examples of the battery system include battery packs, stationary storage battery systems, automobile power storage battery systems, automobile auxiliary storage battery systems, emergency power storage battery systems, and the like.

### EXAMPLES

Hereinbelow, the present invention will be described with reference to Examples and Comparative Examples; however, the present invention should not be construed as being limited to these Examples.

### <Measuring Method>

### [Method for Measuring Specific Surface Area of Positive Electrode Active Material Layer 12 by BET Method]

The specific surface area of the positive electrode active material layer 12 was measured by the BET method following the method described above.

### [Method for Measuring Median Particle Diameter (D50) of Positive Electrode Active Material Layer]

The outermost surface of the positive electrode active material layer with a depth of several μm was removed with a spatula or the like, and the resulting powder was dispersed in water to obtain a dispersion as a sample.

The measurement was implemented using a laser diffraction particle size distribution analyzer (product name “LA-960V2”, manufactured by Horiba, Ltd.), and a flow cell. The sample was circulated, stirred and irradiated with ultrasonic waves (10 minutes), and the particle size distribution was measured while keeping the dispersion state sufficiently stable.

A volume-based particle size distribution curve was obtained to determine the median particle diameter (D50).

### <Measuring Method>

### [Initial Output Performance]

(1) For a non-aqueous electrolyte secondary battery (initial state), the power (unit: mWh) that can be initially output was measured by the following method.

A non-aqueous electrolyte secondary battery (cell) was prepared so as to have a rated capacity of 2.0 Ah. In an environment of 25° C., the obtained cell was charged at a constant current rate of 0.2 C rate (that is, 400 mA) and with a cut-off voltage of 3.6 V, and then charged at a constant voltage with a cut-off current set at 1/10 of the above-mentioned charge current (that is, 40 mA).

Then, in an environment of 25° C., the cell was discharged at a constant current rate of 10 C rate (that is, 20000 mA) and with a cut-off voltage of 1.8 V. The discharge power at this time was defined as the power (unit: mWh) that can be output in the initial state (hereinbelow, also referred to as “initial output”) El.
(2) Then, in an environment of 25° C., the cell was discharged at the cell's 0.2 C rate (that is, 400 mA) and with a cut-off voltage of 3.6 V, and then charged at a constant voltage with a cut-off current set at 1/10 of the above-mentioned charge current (that is, 40 mA) so as to have the cell reach a fully charged state.
(3) The non-aqueous electrolyte secondary battery after the measurement in (1) and the adjustment to full charge in (2) was subjected to a calendar test where the battery was stored in an atmosphere of 60° C. for 30 days (720 hours).
(4) After the calender test of the above (3), the power (unit: Wh) that can be output after the storage was measured by the following method.

Then, in an environment of 25° C., the cell was discharged at a constant current rate of 0.2 C (that is, 400 mA) and with a cut-off voltage of 2.5 V.

Then, in an environment of 25° C., the cell was charged at a constant current rate of 0.2 C rate (that is, 400 mA) and with a cut-off voltage of 3.6 V, and then charged at a constant voltage with a cut-off current set at 1/10 of the above-mentioned charge current (that is, 40 mA).

Then, in an environment of 25° C., the cell was discharged at a constant current rate of 10 C rate (that is, 20000 mA) and with a cut-off voltage of 1.8 V. The discharge power at this time was defined as the power (unit: mWh) that can be output after the storage (hereinbelow, also referred to as “post-storage output”) E2.
(5) The ratio of the post-storage output E2 obtained in (4) to the initial output E1 obtained in (1) was calculated by the following formula to obtain an output retention (unit: %).

$$Output retention = ( E 2 / E 1 ) \times 100$$

### Production Example 1: Production of Negative Electrode

100 parts by mass of artificial graphite as a negative electrode active material, 1.5 parts by mass of styrene-butadiene rubber as a binder, 1.5 parts by mass of carboxymethyl cellulose Na as a thickener, and water as a solvent were mixed, to thereby obtain a negative electrode composition having a solid content of 50% by mass.

The obtained negative electrode composition was applied onto both sides of a copper foil (thickness 8 μm) and vacuum dried at 100° C. Then, the resulting was pressure-pressed under a load of 2 kN to obtain a negative electrode sheet. The obtained negative electrode sheet was punched to obtain a negative electrode.

### Production Example 2: Production of Current Collector Having Current Collector Coating Layer

A slurry was obtained by mixing 100 parts by mass of carbon black, 40 parts by mass of polyvinylidene fluoride as a binder, and N-methyl-2-pyrrolidone (NMP) as a solvent. The amount of NMP used was the amount required for applying the slurry.

The obtained slurry was applied to both sides of a 15 μm-thick aluminum foil (positive electrode current collector main body) by a gravure method so as to allow the resulting current collector coating layers after drying (total of layers on both sides) to have a thickness of 2 μm, and dried to remove the solvent, thereby obtaining a positive electrode current collector. The current collector coating layers on both surfaces were formed so as to have the same amount of coating and the same thickness.

### Examples 1 to 3, Comparative Examples 1 to 3

As the positive electrode active material particles, the following three types of lithium iron phosphate particles having a coated section (hereinafter, also referred to as “carbon-coated active material”) were used. In the following description, the median particle diameter is a volume-based median diameter as described above.

Carbon-coated active material (0.5): median particle diameter 1.0 μm, carbon content 1.5% by mass.

Carbon-coated active material (1.0): median particle diameter 1.2 μm, carbon content 1.5% by mass.

Carbon-coated active material (4.7): median particle diameter 4.7 μm, carbon content 2.5% by mass.

Carbon-coated active material (17.1): median particle diameter 17.1 μm, carbon content 2.5% by mass.

In all of the carbon-coated active materials (0.5), (1.0), (4.7), and (17.1), the thickness of the active material coating section was within the range of 1 to 100 nm.

Carbon black (CB) or carbon nanotube (CNT) was used as the conducting agent. Impurities in the CB and the CNT are below the quantification limit; therefore, both of the CB and the CNT can be regarded as having a carbon content of 100% by mass.

Polyvinylidene fluoride (PVDF) was used as a binder.

Polyvinylpyrrolidone (PVP) was used as a dispersant.

N-methyl-2-pyrrolidone (NMP) was used as a solvent.

An aluminum foil with a current collector coating layer obtained in Production Example 2, or a 15 μm-thick aluminum foil without a current collector coating layer was used as a positive electrode collector.

A positive electrode active material layer was formed by the following method.

The positive electrode active material particles, the conducting agent, the binder, the dispersant, and the solvent (NMP) were mixed in a mixer to obtain a positive electrode composition. The amount of the solvent used was the amount required for applying the positive electrode composition. The blending amounts of the positive electrode active material particles, the conducting agent, the binder and the dispersant in the table are percentage values relative to the total 100% by mass excluding the solvent, that is, the total amount of the positive electrode active material particles, the conducting agent, the binder, and the dispersant.

The obtained positive electrode composition was applied to both surfaces of the positive electrode current collector, and after pre-drying, the applied composition was vacuum-dried at 120° C. to form positive electrode active material layers. The positive electrode active material layers on both surfaces of the positive electrode current collector were formed so as to have the same coating amount and the same thickness. The obtained laminate was pressure-pressed to obtain a positive electrode sheet.

The obtained positive electrode sheet was punched to obtain a positive electrode.

A non-aqueous electrolyte secondary battery having a configuration shown in FIG. 2 was manufactured by the following method.

LiPF₆ as an electrolyte was dissolved at 1 mol/L in a solvent in which ethylene carbonate (EC) and diethyl carbonate (DEC) were mixed at a volume ratio, EC:DEC, of 3:7, to thereby prepare a non-aqueous electrolytic solution.

The positive electrode obtained in this example and the negative electrode obtained in Production Example 1 were alternately interleaved through a separator to prepare an electrode layered body with its outermost layer being the negative electrode. A polyolefin film (thickness 15 μm) was used as the separator.

In the step of producing the electrode layered body, the separator 2 and the positive electrode 1 were first stacked, and then the negative electrode 3 was stacked on the separator 2.

Terminal tabs were electrically connected to the exposed section 13 of the positive electrode current collector and the exposed section 33 of the negative electrode current collector in the electrode layered body, and the electrode layered body was put between aluminum laminate films while allowing the terminal tabs to protrude to the outside. Then, the resulting was laminate-processed and sealed at three sides.

To the resulting structure, a non-aqueous electrolytic solution was injected from one side left unsealed, and this one side was vacuum-sealed to manufacture a non-aqueous electrolyte secondary battery (laminate cell).

TABLE 1

| | | | Median | | | | Output | |
|---|---|---|---|---|---|---|---|---|
| | | BET | particle | | | | performance | |
| | | specific | diameter of | | | | after calender | |
| | | surface area | positive | | | Initial | test in 60° | |
| | Positive | of positive | electrode | | | output | atmosphere | |
| | electrode | electrode | active | Conductive | Conducting | performance | for 30 days | |
| | active | active | material | carbon | agent | 10 C | 10 C | Output |
| | material | material | layer (D50) | content | content | discharge | discharge | retention |
| | particle | layer [m²/g] | [μm] | [mass %] | [mass %] | [mWh] | [mWh] | [%] |
| Ex. 1 | Carbon- | 17.5 | 1.3 | 1.5 | 0.0 | 4600 | 4300 | 93 |
| | coated | | | | | | | |
| | active | | | | | | | |
| | material | | | | | | | |
| | (1.0) | | | | | | | |
| Ex. 2 | Carbon- | 19.9 | 0.9 | 1.5 | 0.0 | 5000 | 4800 | 96 |
| | coated | | | | | | | |
| | active | | | | | | | |
| | material | | | | | | | |
| | (0.5) | | | | | | | |
| Ex. 3 | Carbon- | 23.1 | 0.6 | 2.5 | 1.0 | 5500 | 5200 | 95 |
| | coated | | | | | | | |
| | active | | | | | | | |
| | material | | | | | | | |
| | (0.5) | | | | | | | |
| Comp. | Carbon- | 34.3 | 0.3 | 5 | 3.5 | 5600 | 1300 | 23 |
| Ex. 1 | coated | | | | | | | |
| | active | | | | | | | |
| | material | | | | | | | |
| | (0.5) | | | | | | | |
| Comp. | Carbon- | 14.8 | 56 | 2.5 | 0.0 | 5200 | 3300 | 63 |
| Ex. 2 | coated | | | | | | | |
| | active | | | | | | | |
| | material | | | | | | | |
| | (17.1) | | | | | | | |
| Comp. | Carbon- | 8.4 | 7.8 | 2.5 | 0.0 | 5400 | 3700 | 69 |
| Ex. 3 | coated | | | | | | | |
| | active | | | | | | | |
| | material | | | | | | | |
| | (4.7) | | | | | | | |

As shown in the results in Table 1, Example 1 is appropriate in terms of the specific surface area of the positive electrode active material layer 12 measured by the BET method and the median particle diameter (D50) of the positive electrode active material layer, so that even when stored in a high-temperature environment, the product of Example 1 is unlikely to suffer from the breakage of conductive path due to expansion inside the positive electrode active material particles, and the accompanying side reaction with the electrolyte and resistance increase. Even if the binding strength of the binder decreases due to thermal degradation, the conductive path is maintained and the lowering of output is small.

In Example 2, the median particle diameter (D50) of the positive electrode active material layer is smaller than that of Example 1, so the lowering of output is smaller.

In Example 3, the median particle diameter (D50) of the positive electrode active material layer is smaller than that of Example 1, so the lowering of output is smaller.

In Comparative Example 1, the amount of the conducting agent was larger than that of Example 1, resulting in a smaller median particle diameter (D50) of the positive electrode active material layer and a larger specific surface area of the positive electrode active material layer 12 measured by the BET method, so that the side reactivity increased and the output performance decreased.

In Comparative Example 2, granulated positive electrode active material particles were used, so that the median particle diameter (D50) of the positive electrode active material layer was large and the positive electrode active material particles were agglomerated. Therefore, when exposed to a high temperature environment in the calendar test, the conductive path deteriorated as a result of expansion of the positive electrode active material particles or decrease in the binding strength of the binder, resulting in a lower output performance.

In Comparative Example 3, the median particle diameter (D50) of the positive electrode active material layer was smaller than in Comparative Example 2, and the output performance improved compared to Comparative Example 2, but the effect of the improvement was limited.

### EXPLANATION OF REFERENCE NUMERALS

1 Positive electrode (positive electrode for non-aqueous electrolyte secondary battery)
2 Separator
3 Negative electrode
5 Outer casing
10 Non-aqueous electrolyte secondary cell
11 Current collector (positive electrode current collector)
12 Positive electrode active material layer
13 Exposed section of positive electrode current collector
14 Positive electrode current collector main body
15 Current collector coating layer
31 Negative electrode current collector
32 Negative electrode active material layer
33 Exposed section of negative electrode current collector

1. A positive electrode for a non-aqueous electrolyte secondary battery, comprising a current collector and a positive electrode active material layer which includes positive electrode active material particles and is provided on the current collector, wherein:
the positive electrode active material layer has a BET specific surface area of 10 m²/g or more and 30 m²/g or less; and
a median particle diameter (D50) of particles present in the positive electrode active material layer is 0.5 μm or more and 1.5 μm or less, as measured by a laser diffraction scattering method with respect to the positive electrode active material layer having been peeled off.

2. The positive electrode according to claim 1, wherein the positive electrode active material layer comprises a conductive carbon, and an amount of the conductive carbon is 0.5% by mass or more and less than 3.5% by mass, based on a total mass of the positive electrode active material layer.

3. The positive electrode according to claim 1, wherein the positive electrode active material particles comprise a compound represented by a formula LiFeₓM₍₁₋ₓ₎PO₄, wherein 0≤x≤1, M is Co, Ni, Mn, Al, Ti or Zr.

4. The positive electrode according to claim 1, wherein a current collector coating layer comprising a conductive material is present on at least a part of a surface of the positive electrode current collector on a side of the positive electrode active material layer.

5. The positive electrode according to claim 1, wherein the positive electrode active material layer does not contain a conducting agent.

6. A non-aqueous electrolyte secondary battery, comprising the positive electrode of claim 1, a negative electrode, and a non-aqueous electrolyte disposed between the positive electrode and the negative electrode.

7. A battery module or battery system comprising a plurality of the non-aqueous electrolyte secondary batteries of claim 6.

8. A non-aqueous electrolyte secondary battery, comprising the positive electrode of claim 2, a negative electrode, and a non-aqueous electrolyte disposed between the positive electrode and the negative electrode.

9. A battery module or battery system comprising a plurality of the non-aqueous electrolyte secondary batteries of claim 8.

10. A non-aqueous electrolyte secondary battery, comprising the positive electrode of claim 3, a negative electrode, and a non-aqueous electrolyte disposed between the positive electrode and the negative electrode.

11. A battery module or battery system comprising a plurality of the non-aqueous electrolyte secondary batteries of claim 10.

12. A non-aqueous electrolyte secondary battery, comprising the positive electrode of claim 4, a negative electrode, and a non-aqueous electrolyte disposed between the positive electrode and the negative electrode.

13. A battery module or battery system comprising a plurality of the non-aqueous electrolyte secondary batteries of claim 12.

14. A non-aqueous electrolyte secondary battery, comprising the positive electrode of claim 5, a negative electrode, and a non-aqueous electrolyte disposed between the positive electrode and the negative electrode.

15. A battery module or battery system comprising a plurality of the non-aqueous electrolyte secondary batteries of claim 14.
